(19) United States
(12) Patent Application Publication
(10) Pub. No.: US 2008/0142760 A1
(43) Pub. Date: Jun. 19, 2008

(54) PORTABLE PRESS POWDER FOR LATENT FINGERPRINTS AND METHOD FOR PREPARING THE SAME

(75) Inventors: Kyung-Taek SHIN, Seoul (KR); Ho-Chul SUNG, Gyeonggi-Do (KR); Ju-Hong MIN, Daejeon (KR); Seon-Young PARK, Chungcheongbuk-Do (KR); Hwa-Kyong JUNG, Chungcheongbuk-Do (KR); Sang-Chun KIM, Chungcheongbuk-Do (KR)

Correspondence Address: GREENBLUM & BERNSTEIN, P.L.C., 1950 ROLAND CLARKE PLACE, RESTON, VA, 20191, US

(73) Assignees: Kyung-Taek SHIN, Seoul (KR); Ho-Chul SUNG, Gyeonggi-Do (KR); BOKWANG Chemical Co., Ltd., Chungcheongbuk-Do (KR)

(21) Appl. No.: 11/874,476

(22) Filed: Oct. 18, 2007

(30) Foreign Application Priority Data
Oct. 20, 2006 (KR) 10-2006-0102105

(51) Int. Cl. C09D 1/00

(52) U.S. Cl. 252/408.1; 106/31.6; 106/31.9

(57) ABSTRACT

There are provided a portable press powder for latent fingerprints using natural minerals capable of taking latent fingerprints from a surface of a material object, the latent fingerprints being left when the material object is touched with a hand but invisible to the naked eye, and a method for preparing the same. The portable press powder for latent fingerprints according to the present invention can be useful to take clear fingerprints in more economical manner since it is safe to human body and the powder scattering is low when compared to the conventional blackish powders, and thus, it is environment-friendly, easy to take fingerprints and easy to handle a powder.

### CROSS-REFERENCE TO RELATED APPLICATIONS

This application claims the priority of Korean Patent Application No. 2006-0102105, filed on Oct. 20, 2006, in the Korean Intellectual Property Office, the disclosure of which is incorporated herein by reference.

### BACKGROUND OF THE INVENTION

1. Field of the Invention

The present invention relates to a portable press powder for latent fingerprints and a method for preparing the same, and more particularly to a portable press powder for latent fingerprints using natural minerals capable of taking latent fingerprints from a surface of a material object, the latent fingerprints being left when the material object is touched with a hand but invisible to the naked eye, and a method for preparing the same.

2. Description of the Related Art

How to effectively detect latent fingerprints is one of important factors since the fingerprints that are important evidence is very important in criminal investigations to ferret out, arrest and accuse the criminals.

Fingerprints are left on a material object touched by a suspected person because eccrine sweat glands, apocrine sweat glands and sebaceous glands are present in the skins of humans, and ridge and furrow patterns of the finger prints are left by the materials secreted from the sweet glands. That is to say, considering that the ridge and furrow correspond respectively to depressed engraving and raised carving portions of a stamp, a secretion from the sweat glands or sebaceous glands correspond to a red stamping ink. At this time, the secreted material is composed of a small amount of inorganic materials such as chlorides or metal ions, and organic materials such as amino acids, urea, proteins, carbohydrates, fatty acids, etc. Here, the secreted material is not easily observed with the naked eye since it is colorless.

Various physicochemical techniques including a Ninhydrin method, a powder method and an instant glue method have been used to detect these latent fingerprints, depending on the characteristics of a specimen surface or the contamination level of the fingerprints. In particular, among them, the powder method of fixing powder on fingerprints and observing ridges of the fingerprints with the naked eye is the most basic and common method, and used the most widely.

In general, the powder method is a method of taking fingerprints by applying powder to a surface of a material object using powder and brushes for taking a fingerprint so as to take latent fingerprints left in the surface of the material object. More particularly, the powder method is a method of determining a fingerprint by rubbing a surface of a specimen, to which a fingerprint is attached or considered to be attached, with brushes covered with graphite, aluminum powder and the like to fix the powder in latent fingerprints and visualize the latent fingerprints, and transferring the powder on the latent fingerprints to a gelatin film. The powder method is widely used to take a latent fingerprints from a material object, such as glasses or aluminum, having a smooth surface.

However, for the above-mentioned method of taking a fingerprint, the conventional powder used to take a fingerprint from the scene of a crime is in a powdery state, and therefore the powder is severely scattered around and its adhesion to the fingerprints is low when it is rubbed with brushes or smeared on a specimen surface. Therefore, it has been reported that the powder pollutes surrounding environments as shown in FIG. 1, and also causes lethal diseases to humans, including bronchial diseases, asthma, allergy and the like, when the powder flows through the respiratory organs of the humans or is in contact with their skins since it includes carbon components or metals such as aluminum.

Also, the using of the powder has been shirked since victims are dissatisfied due to the pollution of the air in the room and damages to commodities such as home appliances or furniture by the powder, and therefore fingerprint detection efficiency is low.

In addition, if the surface of a specimen investigated for the purpose of taking a latent fingerprint is large, or there are a lot of pieces of evidence, the environmental pollutions, the cautions for the safety to humans, the disbelieves by victims have blocked progress in taking fingerprints due to the scattering of the powder in the conventional powder handling.

Therefore, the inventors have ardent attempts to solve the above problems, and found that, when a portable press powder for fingerprints may be prepared using an extender derived from natural minerals, a color pigment, a binder and the like, the press powder is able to significantly reduce the pollutions of the air in the room or the surrounding environments due to the scattering of powder, highly decrease the damage to humans by the intake through human respiratory organs or the skin contacts, and also reduce an amount of the wasted powder since it is prepared in the form of press powder to decrease a volume of the final powder product, which leads to its easy handling and easy working to take a fingerprint. Therefore, the present invention was completed on the basis of the above facts.

### SUMMARY OF THE INVENTION

Accordingly, the present invention is designed to solve such drawbacks of the prior art, and therefore an object of the present invention is to provide a portable press powder for latent fingerprints in which a powder is not scattered, and a method for preparing the same.

Also, another object of the present invention is to provide a method for taking a fingerprint using the portable press powder for latent fingerprints prepared by the preparation method.

One embodiment of the present invention is achieved by providing a portable press powder for latent fingerprints in which a powder is not scattered.

The portable press powder for latent fingerprints according to the present invention is composed of an extender derived from natural minerals, a color pigment for exhibiting colors, and a binder for facilitating compression and molding of a powder in a container and preventing scattering of the powder.

The extender is at least one compound selected from the group consisting of natural minerals, and more particularly talc, mica, silica, kaolin, white mica, sericite, magnesium carbonate, calcium carbonate, aluminum silicate, magnesium silicate, barium sulfate, barium carbonate, boron nitride and diatomite, and a pearl luster pigment such as titanated mica and oxy chlorobismuth, and an organic powder such as polymeric materials (including nylon, poly(methyl methacrylate), polyethylene, etc.) may be additionally used in addition to the above compounds, depending on the use of the extender. At this time, an amount of the added extender preferably ranges from 0.1 to 70% by weight, and more preferably from 1 to 40% by weight.

Also, at least one achromatic or chromatic powder is used as the color pigment, including various inorganic or organic pigments. More particularly, barium sulfate, calcium carbonate, plaster, alumina, zinc oxide, silicon oxide or titanium oxide and mixtures thereof may be used as the whitish achromatic color powder, and carbon black, graphite, molybdenum disulfide, iron oxide, Silica Black, Chrome Black, Mineral Black or silicon carbide and mixtures thereof may be used as the blackish achromatic color powder.

Also, the chromatic powder, which may be used herein, includes red pigments such as red iron oxide, Cadmium Red, Molybdenum Red and copper ferrocyanide; yellow pigments such as chrome yellow, yellow iron oxide, yellow ocher, barium sulfur and cadmium sulfur; green pigments such as Chrome Green, Cobalt Green, Manganese Green, Iron Green, copper phosphate, bronze powder and verdigris; blue pigments such as Prussian blue, ultramarine, Cobalt Blue and Tungsten Blue; metallic powders such as other aluminum powder and copper metallic powder; organic pigments such as azo pigment, anthraquinone pigment and indigo derivatives; and fluorescent pigments such as silver-doped zinc oxide and luminous copper-plated zinc sulfide. At this time, an amount of the used color pigment preferably ranges from 1 to 99% by weight, and more preferably from 10 to 99% by weight.

According to the present invention, the extender and color pigments may be also used in the form of powder in themselves, but they are more preferably surface-modified with surface-modifying ingredients to improve dispersibility and adhesion of particles.

As described above, the first object of surface-modifying a surface of a pigment is to improve the above problems of the pigment. Dispersibility to water or oils is improved by the surface treatment, and it is possible to improve light fastness and solvent resistance and suppress surface activity. The second object is to give new functions which a pigment does not have. That is to say, new use feeling is given to a pigment and new physical properties, such as water-repellent treatment, are given to the pigment. Due to the water-repellent treatment, it is possible to prepare a press powder that may be used in both of the presence and absence of water.

A surfactant, metallic soap, silicone, fluorine compounds, oils and the like may be used as the surface-modifying ingredients to treat a powder, and their characteristics are described in detail, as follows.

The surfactant is adhered to a surface of inorganic powders having a high polarity due to hydrophilic groups of its molecular structure and aligned lipophilic groups toward outside. Therefore, lipophilic treatment is possible by adhering a surfactant to functional groups of surfaces of the powder particles. In this case, hydrophilic treatment is also possible since a two-layered adsorbed film is formed by the addition of the surfactant to show water dispersibility. Methylhydrogen polysiloxane, dimethylpolysiloxane or silane compounds may be used as the silicone-treated components. In the case of the treatment of a pigment with silicone, a Si—H bond is oxidized by oxygen in the air only through heating and new Si—O—Si or —Si—O-M (pigment) bonds are generated by reaction with OH of a pigment surface. The powder shows strong water repellency since a thin film on the powder is formed from silicone oil. One of the advantages of the surface treatment by fluorine compounds is that a powder has water repellency and oil repellency at the same time, and one of raw materials that are the most widely used as the fluorine compounds for surface treatment is polyfluoroalkylphosphate ester salt. Among them, polyfluoroalkylphosphate ester diamine salt is representative. A metal soup functions to improve adhesion of powder and show good water repellency. Zinc salt such as myristic acid and stearic acid, and magnesium salt, aluminum salt and the like are used. Wax components including beeswax, cetanol and lecithin may be sued as the components that are used for the surface treatment by fats and oils. In addition, possible surface-modifying components, that may be used herein, include hydrogenated lecithin, basic amino acid and fatty acids, silk fibroin, collagen, chitosan and the like, all of which are used to coat a powder.

Meanwhile, as the binder oil according to the present invention, silicone-based compounds, fluorine-based compounds, hydrocarbon-based compounds, animal/vegetable oils, highly fatty acids or higher alcohols and mixtures thereof are preferably used in an amount of 0.1 to 50% by weight, and more preferably 1 to 20% by weight.

As described above, organosilicon compounds having a siloxane bond are used as the silicone-based compound, and it is preferred to use dimethylpolysiloxane. In addition to the compounds, modified silicones may be used, and it is preferred to use amino-modified silicone, alkyl-modified silicone, carboxyl-modified silicone, polyalkylene-modified silicone or epoxy-modified silicone and mixtures thereof.

Also, fluorine oil and fluorine resin dispersions may be used as the fluorine-based compounds, and it is particularly preferred to use fluorine oil among them.

Also, saturated or unsaturated hydrocarbons having more than 15 carbon atom number, or ester-based oils obtained by dehydrating acids and alkalis are generally preferably used as the hydrocarbon-based oils.

Accordingly, the portable press powder for latent fingerprints of the present invention may be sufficient to be used if it may be visualized by the contact with latent fingerprints, but preferably includes 1 to 40% by weight of an extender, 10 to 99% by weight of a color pigment, and 1 to 20% by weight of a binder. In addition, the portable press powder for latent fingerprints of the present invention may include a preservative and a perfume, both of which are generally added to the powder for taking a fingerprint.

If the extender is present in an amount of less than 1% by weight as described above, it is difficult to disperse a color pigment and maintain a formulation of a press powder, whereas a content of the color pigment is undesirably low if the content of the extender exceeds 40% by weight.

Meanwhile, if the color pigment is added in an amount of less than 10% by weight, resolution degree of a fingerprint is low due to the lack of the adhesion to the latent fingerprints, whereas it is difficult to prepare a formulation of a press powder if the content of the color pigment exceeds 99% by weight.

Also, if the content of the binder is less than 1% by weight or greater than 20% by weight, it is difficult to prepare a portable press powder due to the difficulty in compacting and molding a powder.

Also, the present invention provides the method of preparing a portable press powder for latent fingerprints.

The method for preparing a portable press powder for taking a fingerprint is characterized in that it includes:

(1) adding ingredients of extender to a mixer and mixing while stirring;

(2) adding a color pigment and other remaining powders to the resultant mixture and mixing them;

(3) dispersing/dissolving a preservative and a perfume, if necessary in binder, in a solvent, followed by homogeneously mixing by spraying the resultant mixture to the mixer;

(4) pulverizing the mixture into a constant size using a pulverizer such as an atomizer, followed by sieving the mixture; and

(5) adding the sieved mixture to a compressor case within a suitable amount and molding the mixture with a press.

In the case of the portable press powder for latent fingerprints of the present invention, a press powder for taking a fingerprint may be prepared using the extender and the color pigments in the form of powder, but it is more preferably surface-modified with surface-modifying ingredients to improve dispersibility and adhesion of particles.

Any of methods for preparing a surface-treated pigment used to prepare the portable press powder for latent fingerprints according to the present invention may be used if they are conventionally used methods, but a specific example of the methods will be described in detail.

That is to say, the extender or the color pigment as described above is added into a mixed pulverizer such as a Henschel mixer, and a diluted surface-modified component is sprayed and added respectively to ethanol, isopropyl alcohol, acetone or mixtures thereof and continuously mixed while stirring. Then, when the mixture are thoroughly mixed, a pigment surface is uniformly coated with the modified component, and then heat-treated at about 80 to 200° C. to stabilize the coating, thereby preparing a surface-treated pigment according to the present invention.

The surface-modified component is used in the content range of 0.5 to 10%, and preferably 0.5 to 3%, based on the weight of the raw powder before the surface treatment. If the content of the surface-treated component is too low, it is difficult to give physical properties such as adhesion and dispersibility to a powder, whereas characteristics of the powder are deteriorated if the content of the surface-treated component is too high.

As the other method, a method for preparing a surface-treated pigment according to the present invention is to add a surface-modified component into water-soluble pigment slurry and attach the component to a powder surface. For example, the surface-modified component in the water-soluble pigment slurry may also be added and then attached to a powder surface.

Also, other inorganic and organic components may be used to modify a surface of pigment.

The surface-treated pigment according to the present invention as prepared thus is characterized in that it has excellent dispersibility when compared to the conventional pigments since the surface-modified component is uniformly absorbed and coated on a surface of the pigment in the form of a film, and has an improved resolution degree of a taken fingerprint since its adhesion to oily components of the fingerprint is improved.

Also, the present invention provides a method for taking a fingerprint, characterized in that the portable press powder for latent fingerprints prepared according to the above-mentioned preparation method is used to take a fingerprint.

More particularly, the method for taking a fingerprint according to the present invention is characterized in that it concludes:

(1) searching a target material object to be used to take a fingerprint;

(2) covering by brushes with the portable press powder for latent fingerprints according to the present invention and applying the portable press powder to the target material object;

(3) removing off the remaining powder except for the powder on the fingerprint; and

(4) taking a picture of the visualized fingerprint and transferring the picture into a transfer paper.

### BRIEF DESCRIPTION OF THE DRAWINGS

The above and other aspects, features and other advantages of the present invention will be more clearly understood from the following detailed description taken in conjunction with the accompanying drawings, in which:

FIG. 1 is a diagram showing a portable press powder for latent fingerprints according to an exemplary embodiment of the present invention.

FIG. 2 is a diagram showing a procedure of taking a fingerprint using the portable press powder for latent fingerprints according to an exemplary embodiment of the present invention.

FIG. 3 shows a result of taking a fingerprint from an aluminum can using a black press powder according to an exemplary embodiment of the present invention.

FIG. 4 shows a result of taking a fingerprint from an incandescent lamp using a black press powder according to an exemplary embodiment of the present invention.

FIG. 5 shows a result of taking a fingerprint from pieces of broken glass using a black press powder according to an exemplary embodiment of the present invention.

FIG. 6 shows a result of taking a fingerprint from a glass bottle using a white press powder according to an exemplary embodiment of the present invention.

FIG. 7 shows a result of taking a fingerprint from an aluminum can using a silver press powder according to an exemplary embodiment of the present invention.

FIG. 8 is a diagram showing a procedure of taking a fingerprint using a conventional black powder for taking a fingerprint.

### DETAILED DESCRIPTION OF THE PREFERRED EMBODIMENT

Exemplary embodiments of the present invention will now be described in detail with reference to the accompanying drawings. However, the description proposed herein is just a preferable example for the purpose of illustrations only, not intended to limit the scope of the invention, so it should be understood that other equivalents and modifications could be made thereto without departing from the spirit and scope of the invention. Therefore, the shapes and sizes of parts shown in the accompanying drawings may be expressed exaggeratedly for clarity and the same parts have the same reference numerals in the accompanying drawings.

### Example 1

### Preparation of Talc Pigment Surface-Treated with Dimethiconol Stearate

500 g of a talc powder as a cosmetic extender was added to a laboratory Henschel mixer, and 15 g of dimethiconol stearate was dissolved in 500 ml of ethanol. Then the mixture was sprayed inwardly to the Henschel mixer using a sprayer.

After stirring thoroughly for 20 minutes, powder was recovered, dried and heated at 120° C. in a drying machine overnight. The dried powder was pulverized with a hand mixer to prepare talc surface-treated with silicone fatty ester.

### Example 2

### Preparation of Black Iron Oxide Pigment Surface-Treated with Silane Compounds

50 g of black iron oxide was added to a 1 l beaker holding purified water 500 ml, and stirred thoroughly to prepare slurry.

The slurry was warmed to 70° C., and 1.5 g of octylsilane was added by drop to mix and dissolve two compounds thoroughly, and an aqueous 0.1 M hydrochloric solution was then added by drop to the resultant mixture, and stirred while maintaining pH to 3 to 4.

When the reaction is completed, the black pigment was washed three times with purified water, dehydrated, filtered, and heat-dried to 105° C. for 10 hours. Then, the dried black pigment was pulverized using a hand mixer to prepare a surface-modified black pigment.

### Example 3

### Preparation of Formulation of Portable Press Powder for Latent Fingerprints

A press powder for taking fingerprints was prepared using the surface-modified pigment prepared in Examples 1 and 2 and Formulation examples listed in the following Table 1.

TABLE 1

| | | | Formulation examples | | | | |
|---|---|---|---|---|---|---|---|
| | | | 1 | 2 | 3 | | |
| | Pigments | Components | (Black) | (White) | (Silver) | | |
| Extender | TALC | Talc | 8.5 | 56.0 | 53.6 | | |
| | DMS | surface-treated | | | | | |
| | | with | | | | | |
| | | dimethiconol | | | | | |
| | | stearate | | | | | |
| | Mica | Mica | 2.0 | 25.0 | 6.0 | | |
| | DS | surface-treated | | | | | |
| | | with | | | | | |
| | | dimethicone | | | | | |
| | Silica | Anhydrous | — | 0.5 | 0.5 | | |
| | | silicic acid | | | | | |
| | Pearl | Titanated Mica | — | — | 20.0 | | |
| | White | (white luster | | | | | |
| | | pigment) | | | | | |
| | Color | TiO₂ DS | Titanium dioxide | 5.0 | 10.0 | 10.0 | |
| | powder | | surface-treated | | | | |
| | | | with dimethicone | | | | |
| | | I.O. Black CS | Black iron oxide | 55.0 | — | 2.0 | |
| | | | surface-treated | | | | |
| | | | with octyl silane | | | | |
| | | I.O. Black DS | Black iron oxide | 25.0 | — | — | |
| | | | surface-treated | | | | |
| | | | with dimethicone | | | | |
| | | UMB DS | Ultramarine Blue | — | — | 0.4 | |
| | | | surface-treated | | | | |
| | | | with dimethicone | | | | |
| | | Binder | Caprylic/capric | Caprylic/ | 4.0 | 8.0 | 7.0 |
| | | | triglyceride | capric | | | |
| | | | | triglyceride | | | |
| | | | | (hydro- | | | |
| | | | | carbon- | | | |
| | | | | based | | | |
| | | | | oil) | | | |
| | | | Methylparaben | Methylparaben | 0.1 | 0.1 | 0.1 |
| | | | | (preservative) | | | |
| | | | Butylparaben | Butylparaben | 0.1 | 0.1 | 0.1 |
| | | | | (preservative) | | | |
| | | | Perfume | Perfume | 0.3 | 0.3 | 0.3 |

More particularly, talc surface-treated with dimethiconol stearate, mica surface-treated with dimethicone, anhydrous silicic acid, and titanated mica were added to a Henschel mixer as the extender according to respective Formulation examples, and mixed twice while stirring at a low speed. Then, black iron oxide surface-treated with dimethicone, black iron oxide surface-treated with octylsilane, black iron oxide surface-treated with dimethicone, and Ultramarine surface-treated with dimethicone as the color pigments were added to the resultant mixture, and mixed twice while stirring at a high speed, and a binder caprylic-caprictriglyceride and a mixed perfume, which is previously prepared by dispersing and dissolving preservatives such as methylparaben and butylparaben, were then sprayed inwardly to a Henschel mixer, and mixed while stirring.

The resultant mixture was pulverized using an atomizer, sieved, added to a compressor case in a suitable amount, and then pressured and molded using a press according to the conventional methods.

Meanwhile, conventional black powder particles (commercially available from Lightning Power, USA), which have been used to take a fingerprint, were used in Comparative examples.

### Experimental Example 1

### Names Obtained by Taking Fingerprints using Portable Press powder for Latent Fingerprints

Operations of taking fingerprints were carried out by 42 scientific investigators from the countrywide police offices and Police Academy for 43 days according to the conventional method for taking fingerprints using the press powder prepared in Formulation example 1 of Example 3, and 5 items (including: Visualization state of fingerprints in comparison to the conventional black powder in taking fingerprints; Easiness and portability in use of the press powder of the present invention; Intake of powder through the human respiratory organs in taking fingerprints; Pollution of the air in the room or environments by the powder in criminal sites, victims' houses, etc.; and Damages to home appliances by the powder) were investigated, and the results are listed in the following Table 2.

TABLE 2

| | Police | | State of Taken | Easiness/ | Intake of Powder | Surrounding | Damage to |
|---|---|---|---|---|---|---|---|
| | Stations (PS) | Names | Fingerprint | Portability | into Human | Pollution | Product |
| 1 | Yongsan PS | ( )yeol, Ryu | | | Δ | ◯ | ◯ |
| 2 | Yongsan PS | Gun( ), Lim | | | ◯ | ◯ | ◯ |
| 3 | Yongsan PS | ( )cheol Cho | ◯ | | ◯ | ◯ | |
| 4 | Eunpyoung PS | Min( ), Koh | | | ◯ | | |
| 5 | Eunpyoung PS | ( )ieong, Song | | | ◯ | | |
| 6 | Eunpyoung PS | Ho( ), Jeong | | | ◯ | | ◯ |
| 7 | Eunpyoung PS | ( )hee, Hwang | | | ◯ | ◯ | |
| 8 | Dobong PS | Jea( ), Lee | | | ◯ | ◯ | |
| 9 | Dobong PS | ( )yeol, Kim | | | ◯ | ◯ | |
| 10 | Dobong PS | Ho( ), Park | | | ◯ | | |
| 11 | Dobong PS | ( )hong, Park | | | | | |
| 12 | Guro PS | Ki( ), Cheong | | | ◯ | | |
| 13 | Guro PS | ( )hyeon, Kwak | | | | | ◯ |
| 14 | Guro PS | Do( ), Nah | ◯ | | ◯ | | |
| 15 | Mokpo PS | ( )heup, Choi | | | ◯ | ◯ | ◯ |
| 16 | Mokpo PS | Jeong( ), Oh | | | | | |
| 17 | Mokpo PS | ( )hun, Choi | | | | | |
| 18 | NCPA | Hea( ), Lee | | | ◯ | Δ | |
| 19 | NCPA | ( )hee, Han | | | | Δ | |
| 20 | NCPA | Ki( ), Cheon | | | ◯ | ◯ | ◯ |
| 21 | NCPA | ( )hak, Lee | | | | | |
| 22 | NCPA | ( )sang, Yang | | | | | |
| 23 | NCPA | Bok( ), Kim | | | | | |
| 24 | NCPA | ( )jun, Koh | | | | | |
| 25 | NCPA | Chung( ), Park | | | | | ◯ |
| 26 | Chungrang PS | ( )seong, Cheong | | | | | |
| 27 | Pusnajin PS | Tae( ), Kim | | ◯ | ◯ | ◯ | |
| 28 | Pusnajin PS | ( )soo, Anh | | ◯ | | ◯ | ◯ |
| 29 | Pusnajin PS | Seong( ), Song | | | | ◯ | ◯ |
| 30 | Pusnajin PS | ( )yong, Cha | | | | ◯ | ◯ |
| 31 | KeumCheon PS | Man( ), Yeon | ◯ | | ◯ | ◯ | |
| 32 | KeumCheon PS | ( )man, Koh | ◯ | | | | |
| 33 | KeumCheon PS | Yong( ), Chang | ◯ | | | | |
| 34 | Seodaemum PS | ( )hum, Lee | ◯ | | | | |
| 35 | Seodaemum PS | Chong( ), Bae | ◯ | | ◯ | ◯ | Δ |
| 36 | Seodaemum PS | ( )seong, Ryu | | ◯ | ◯ | Δ | ◯ |
| 37 | Seodaemum PS | Seong( ), Hong | ◯ | ◯ | ◯ | ◯ | ◯ |
| 38 | Mapo PS | ( )sun, Lee | | | | ◯ | |
| 39 | Mapo PS | Hwa( ), Lee | | | | ◯ | |
| 40 | Mapo PS | ( )jin, Lee | | | ◯ | ◯ | ◯ |
| 41 | Mapo PS | Chun( ), Oh | | ◯ | ◯ | ◯ | ◯ |
| 42 | KPSI Center | ( )hwan, Chang | ◯ | | | ◯ | |

Evaluation degrees
: Very satisfied, ◯: Satisfied, Δ: Mean, X: Unsatisfied
Note:
Yongsan PS = Yongsan Police Station in Seoul, Eunpyoung PS = Eunpyoung Police Station in Seoul, Dobong PS = Dobong Police Station in Seoul, Guro PS = Guro Police Station in Seoul, Mokpo PS = Mokpo Police Station in Jeollanam-do, NCPA PS = National Central Police Academy, Chungrang SP = Chungrang Police Station in Seoul, Pusnajin PS = Pusnajin Police Station in Seoul, KeumCheon PS = KeumCheon Police Station in Seoul, Seodaemum PS = Seodaemum Police Station in Seoul, Mapo PS = Mapo Police Station in Seoul, KPSI Center = Korean Police Scientific Investigation Center
Results
(1) State of taken fingerprints
More excellent than the conventional powder: 33 persons, and
The same performance as the conventional powder: 9 persons
(2) Easiness and Portability
Very good: 38 persons, and Good: 5 persons
(3) Intake into Human Respiratory Organs in Use of Powder
No intake at all: 20 persons,
Slight intake: 21 persons, and Mean: 1 person
(4) Surrounding Pollution level
Not polluted at all: 19 persons,
Slightly polluted: 12 persons, and Mean: 3 persons
(5) Damages of Product by Powder
Not damaged at all: 27 persons,
Slightly damaged: 15 persons, and Mean: 1 person

As listed in the Table 2, it was revealed that, when the operations of taking a fingerprint were carried out using the portable press powder for latent fingerprints of the present invention, the visualization state of the taken fingerprints is better three times or more than that of the convention methods, and its portability and easiness are improved up to 8 times when compared to the convention methods.

Also, it was revealed that the intake through the human respiratory organs is highly reduced when compared to the conventional powders, and there are hardly the surrounding pollutions and damages to commodities in taking fingerprints, and the easiness and efficiency of the fingerprint-taking operations are highly good.

### Experimental Example 2

### Comparison of Detection State of Fingerprints

Glass bottles, office supplies, incandescent lamps and aluminum cans, all of which have a high detection frequency of fingerprints in criminal sites, were used as specimens to be taken, and 42 scientific investigators of the Experimental example 1 were ordered to imprint their fingerprints in respective specimen, take the fingerprints using the portable press powder for latent fingerprints prepared in Example 3 and transfer the fingerprints into a transfer paper.

Identification and clearness of the taken latent fingerprints were observed and evaluated with the naked eye, and the results of the visualization state were dividedly evaluated into 5 levels. At this time, a very clear state is set to level 5, a rather clear state is set to level 4, a middle clearness is set to level 3, a rather unclear state is set to level 2, a very unclear state is set to level 1, and mean values of their evaluated values were calculated. The results are listed in the following Table 3.

TABLE 3

| Formulation | | Incandescent | | Office |
|---|---|---|---|---|
| example | Glass bottle | lamp | Aluminum Can | furniture |
| 1 | 4.8 | 4.7 | 4.2 | 4.6 |
| 2 | 4.7 | 4.4 | 4.4 | 4.6 |
| 3 | 4.7 | 4.2 | 4.2 | 4.4 |
| Comparative | 3.5 | 2.8 | 3.1 | 2.2 |
| example | | | | |

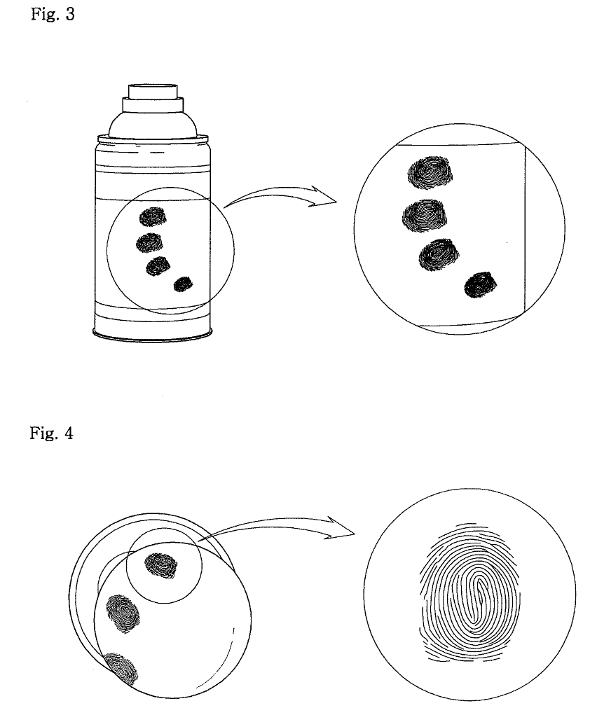

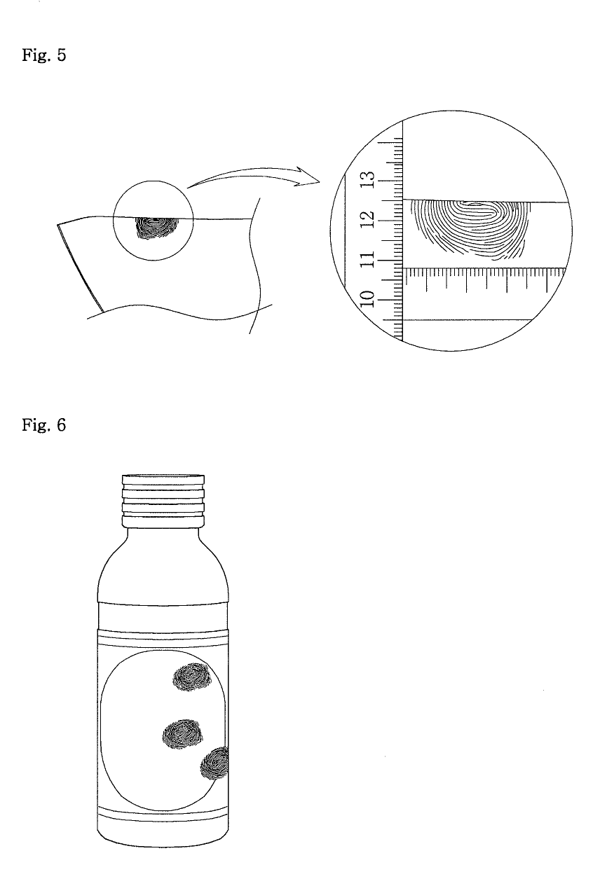

FIGS. 3 to 7 show the results according to the Formulation examples of the portable press powder for latent fingerprints according to the present invention. Here, FIG. 3 shows the result of taking fingerprints from respective aluminum cans using the black press powder of Formulation example 1, and FIGS. 4 and 5 shows the results of taking fingerprints from an incandescent lamp and pieces of broken glass and the results of transferring the fingerprints into a gelatin film.

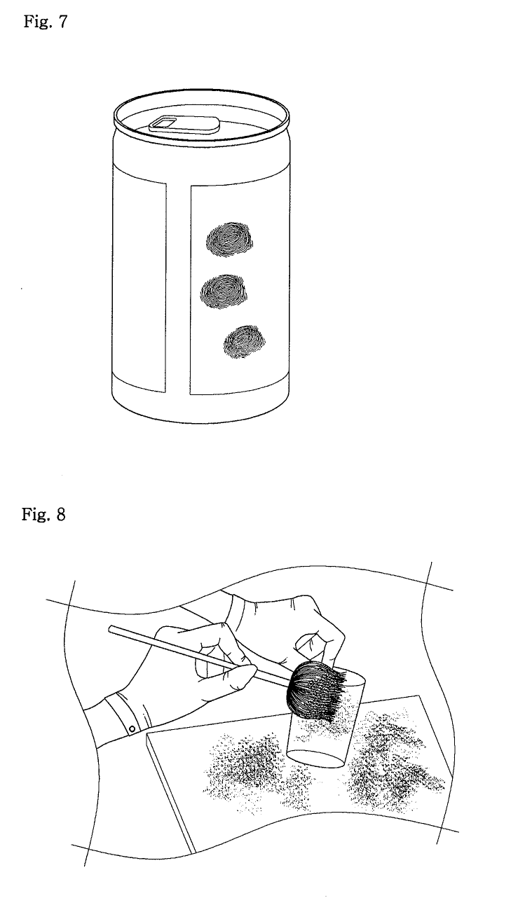

Also, the results of taking fingerprints from a glass bottle using the white press powder of Formulation example 2 is shown in FIG. 6, and the results obtained using the silver press powder of Formulation example 3 is shown in FIG. 7.

Also, the operations of taking fingerprints from surfaces of office furniture and the visualization state of the taken fingerprints were shown in FIG. 8 to evaluate an ability to visualize fingerprints using the conventional black powders and the press powder according to the present invention through their comparison.

As seen from the results of Table 3 and in FIGS. 3 to 7, it was revealed that Formulation examples 1 to 3 of the press powder according to the present invention all have good results. In particular, it was confirmed that it is possible to take fingerprints easily without scattering any of the powder, and the finally visualized state of the fingerprints is very excellent when compared to the conventional black powders, as shown in FIG. 2 illustrating a procedure of taking a fingerprint using the portable press powder for latent fingerprints according to the present invention (see FIGS. 3 to 7). This is considered that fingerprints may be more clearly detected since the surface-coated silane or silicone, or an oily component used as the binder is easily adhered to the oily components of latent fingerprints and fixed in the latent fingerprints.

### Experimental Example 3

### Evaluation of Economical Efficiency

In order to evaluate economical efficiency of the press powder according to the present invention, the 42 scientific investigators of the Experimental example 1 compared and evaluated amounts of the press powders used when they took fingerprints from four specimens including a glass bottle, an incandescent lamp, an aluminum can, office furniture used in Experimental example 2.

An amount of the powder used when the fingerprints are taken using the conventional black powder was measured and set to 100%, and an amount of the powder used when the fingerprints are taken in the same manner using the press powder of the present invention was measured and calculated by percentage. The results are listed in the following Table 4.

TABLE 4

| Amount of | Formulation | | Formulation | | Formulation | | Comparative |
|---|---|---|---|---|---|---|---|
| Used Powder | example 1 | | example 2 | | example 3 | | example |
| Less than 10% | — | | — | | — | | Based on |
| 10~20% | 2 | Persons | 1 | Person | 1 | Person | 100% of the |
| 20~30% | 6 | Persons | 5 | Persons | 3 | Persons | Used |
| 30~40% | 25 | Persons | 27 | Persons | 22 | Persons | Conventional |
| 40~50% | 4 | Persons | 3 | Persons | 7 | Persons | Powder |
| 50~60% | 3 | Persons | 3 | Persons | 5 | Persons | |
| 60~70% | 1 | Person | 1 | Person | 2 | Persons | |
| 70~80% | 1 | Person | 1 | Person | 2 | Persons | |
| 80~90% | — | | 1 | Person | — | | |
| 90~100% | — | | — | | — | | |
| More than | — | | — | | — | | |
| 100% | | | | | | | |
| Total | 42 | Persons | 42 | Persons | 42 | Persons | |

As seen from the results, when the press powder of the present invention was used, an amount of the used press powder is only 30 to 40% of the conventional black powders, and therefore it is reasonable in the aspect of economical efficiency. This is considered to result from the facts that unnecessary waste of the press powder according to the present invention is reduced since it is not scattered and has an excellent visualization of the fingerprints, as shown in FIGS. 2 to 7.

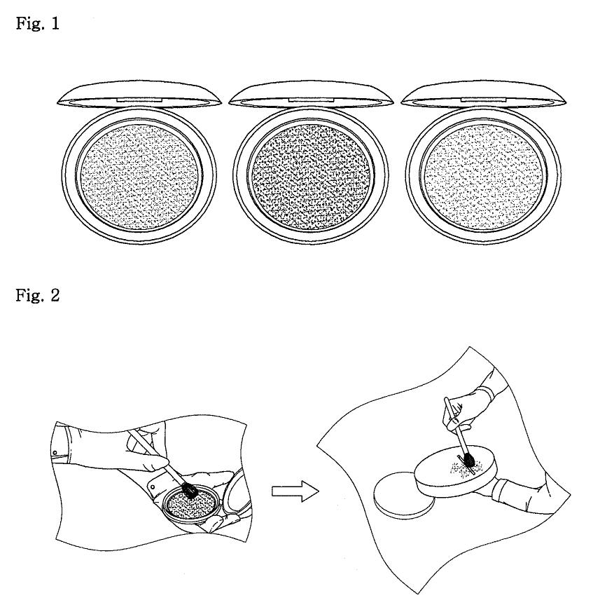

Also, the press powder of the present invention is excellent in the aspect of the economical efficiency since it may be re-used by recharging simple container in an external plastic container with the press powder, as shown in FIG. 1.

As described above, the portable press powder for latent fingerprints according to the present invention is composed of compact powders in a certain container, and therefore the portable press powder may be useful to lower pollutions of the air in the room or the surrounding environments since it is scattered at a highly lower level than the conventional black powder, to minimize victims' dissatisfaction caused due to the decreased damages to commodities such as home appliances by the powder, and to improve the safety to human body by employing a pigment made of natural minerals that are widely used in the fields of foods, medical supplies, cosmetics, etc. since most components of the natural minerals, such as talc, mica, black iron oxide and the like, are proven to be safe.

In the case of the results of taking fingerprints, the portable press powder for latent fingerprints according to the present invention is substantially similar to the conventional powder for taking a fingerprint in the aspect of the ability of visualizing the latent fingerprints, but it has excellent adhesion of the surface-treated powder to the latent fingerprints, and may improve a resolution degree to a surface of the fingerprints since the powder dose not easily attach to the surface except for the fingerprints, thereby showing the state of the finally identified fingerprints clearly.

Also, the portable press powder for latent fingerprints according to the present invention is easy to hold and handle since a color cosmetic container is filled with the pigment in the form of compact powder, thereby decreasing its volume. Also, the portable press powder may be re-used by recharging a container in the external plastic container with the press powder, and has an effect to highly reduce an amount of the used powder when compared to the conventional black powder.

While the present invention has been shown and described in connection with the exemplary embodiments, it will be apparent to those skilled in the art that modifications and variations can be made without departing from the spirit and scope of the invention as defined by the appended claims.

What is claimed is:

1. A portable press powder for latent fingerprints capable of taking latent fingerprints, wherein the powder is composed of an extender derived from natural minerals, a color pigment for exhibiting colors, and a binder for facilitating compression-molding of a powder in a container and preventing scattering of the powder and is molded under a pressure; and the binder oil is selected from the group consisting of silicone-based compounds, fluorine-based compounds, hydrocarbon-based compounds, animal/vegetable oils, fatty acids or mixtures thereof.

2. The portable press powder for latent fingerprints according to claim 1, wherein the extender or color pigment is used as a surface-modified component to prepare a surface-treated pigment by uniformly coating a surface of the pigment with the surface-modified component and heat-treating the surface of the pigment.

3. The portable press powder for latent fingerprints according to claim 1, wherein the extender is at least one compound selected from the group consisting of talc, mica, silica, kaolin, muscovite, sericite, magnesium carbonate, calcium carbonate, aluminum silicate, magnesium silicate, barium sulfate, barium carbonate, boron nitride and diatomite.

4. The portable press powder for latent fingerprints according to claim 1, further comprising at least one compound selected from the group consisting of titanated mica, bismuthoxychloride, nylon, poly(methyl methacrylate) and polyethylene in addition to the extender.

5. The portable press powder for latent fingerprints according to claim 1, wherein the color pigment is at least one compound selected from the group consisting of:
whitish achromatic color powders selected from the group consisting of barium sulfate, calcium carbonate, plaster, alumina, zinc oxide, silicon oxide or titanium oxide and mixtures thereof;
blackish achromatic color powders selected from the group consisting of carbon black, graphite, molybdenum disulfide, iron oxide, Silica Black, Chrome Black, Mineral Black or silicon carbide and mixtures thereof; and
chromatic color powders selected from the group consisting of red pigments including red iron oxide, Cadmium Red, Molybdenum Red and copper ferrocyanide; yellow pigments including chrome yellow, yellow iron oxide, yellow ocher, barium sulfur and cadmium sulfur; green pigments including Chrome green, Cobalt green, Manganese Green, Iron Green, copper phosphate, bronze powder and verdigris; blue pigments including Prussian blue, ultramarine, Cobalt Blue and Tungsten Blue; metallic powders such as other aluminum powder and copper metallic powder; organic pigments such as azo pigment, anthraquinone pigment and indigo derivatives; and fluorescent pigments such as silver-doped zinc oxide and luminous copper-plated zinc sulfide.

6. A method for preparing the portable press powder for latent fingerprints as defined in claim 1, the method comprising:
adding extenders to a mixer and mixing the pigments while stirring and;
adding a color pigment to the mixer and mixing the pigment with the mixture;
spraying into the mixer a binder oil selected from the group consisting of silicone-based compounds, fluorine-based compounds, hydrocarbon-based compounds, animal/vegetable oils, fatty acids or mixtures thereof so as to uniformly mix the binder oil with the resultant mixture;
pulverizing the resultant mixture in the mixer using a pulverizer and sieving the mixture; and
adding the sieved mixture in the previous step to a compressor case and molding the mixture under a pressure using a press.

7. The method according to claim 6, wherein the extender or color pigment is added by spraying a surface-modified component diluted with ethanol, isopropyl alcohol, acetone or mixtures thereof, and a surface-treated pigment is prepared by uniformly coating a pigment surface with the surface-modified component and heat-treating the coated pigment surface at 80 to 200° C. to stabilize a coating.
